(19) United States
(12) Patent Application Publication
(10) Pub. No.: US 2012/0323621 A1
(43) Pub. Date: Dec. 20, 2012

(54) Assisting Customers At A Self-Checkout Terminal

(75) Inventors: K.A. Fredrik Carlegren, Charleston, SC (US); Gregory H. Delott, Raleigh, NC (US); Rosemarie J. Digeorgio, Raleigh, NC (US); Neil A. Girard, Durham, NC (US); Bradley T. Marchesseault, Cary, NC (US); Lydia Schroetter, Raleigh, NC (US); Jeffrey J. Smith, Raleigh, NC (US)

(73) Assignee: INTERNATIONAL BUSINESS MACHINES CORPORATION, Armonk, NY (US)

(21) Appl. No.: 13/163,235

(22) Filed: Jun. 17, 2011

(51) Int. Cl. G06Q 30/00; G06Q 10/00

(52) U.S. Cl. 705/7.13; 705/16

(57) ABSTRACT

Assisting customers at a self-checkout terminal, including: requesting, at the self-checkout terminal, intervention from a shopper assistant; notifying, by the self-checkout terminal, the shopper assistant of the request for intervention; checking in the shopper assistant at the self-checkout terminal; and displaying, at the self-checkout terminal, an additional intervention request initiated at another self-checkout terminal.

### BACKGROUND OF THE INVENTION

1. Field of the Invention

The field of the invention is data processing, or, more specifically, methods, apparatus, and products for assisting customers at a self-checkout terminal.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems and networks today that are much more ubiquitous and powerful than just a few years ago.

One of the most prevalent uses of these powerful computer systems and networks is for self-checkout terminals in retail establishments such as, for example, grocery stores, restaurants, hotels, stadiums, and so on. Each self-checkout terminal is typically located on a checkout counter and used by a shopper to complete customer sales. Each self-checkout terminal is a computing device that typically includes a check/debit card/credit card reader, bar code reader or radio frequency identification (‘RFID’) chip reader, and so on. The self-checkout terminals may communicate over a network to various external transaction systems such as, for example, credit card processing systems, debit card processing systems, check processing systems, and so on.

Shoppers using self-checkout terminals may require assistance from an employee of the retailer. Employees of the retailer may be responsible for assisting customers at many self-checkout terminals. Employees of the retailer, however, typically are only able to assist customers a one self-checkout terminal at a time, leaving other customers at other self-checkout terminals to wait for customer assistance rather than proceeding with a transaction.

### SUMMARY OF THE INVENTION

Methods, apparatus, and products for assisting customers at a self-checkout terminal, including: requesting, at the self-checkout terminal, intervention from a shopper assistant; notifying, by the self-checkout terminal, the shopper assistant of the request for intervention; checking in the shopper assistant at the self-checkout terminal; and displaying, at the self-checkout terminal, an additional intervention request initiated at another self-checkout terminal.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an self-checkout terminal useful in assisting customers at a self-checkout terminal according to embodiments of the present invention.

FIG. 2 sets forth a flow chart illustrating an example method for assisting customers at a self-checkout terminal according to embodiments of the present invention.

FIG. 3 sets forth a flow chart illustrating an example method for assisting customers at a self-checkout terminal according to embodiments of the present invention.

FIG. 4 sets forth a flow chart illustrating an example method for assisting customers at a self-checkout terminal according to embodiments of the present invention.

### DETAILED DESCRIPTION OF EXAMPLE EMBODIMENTS

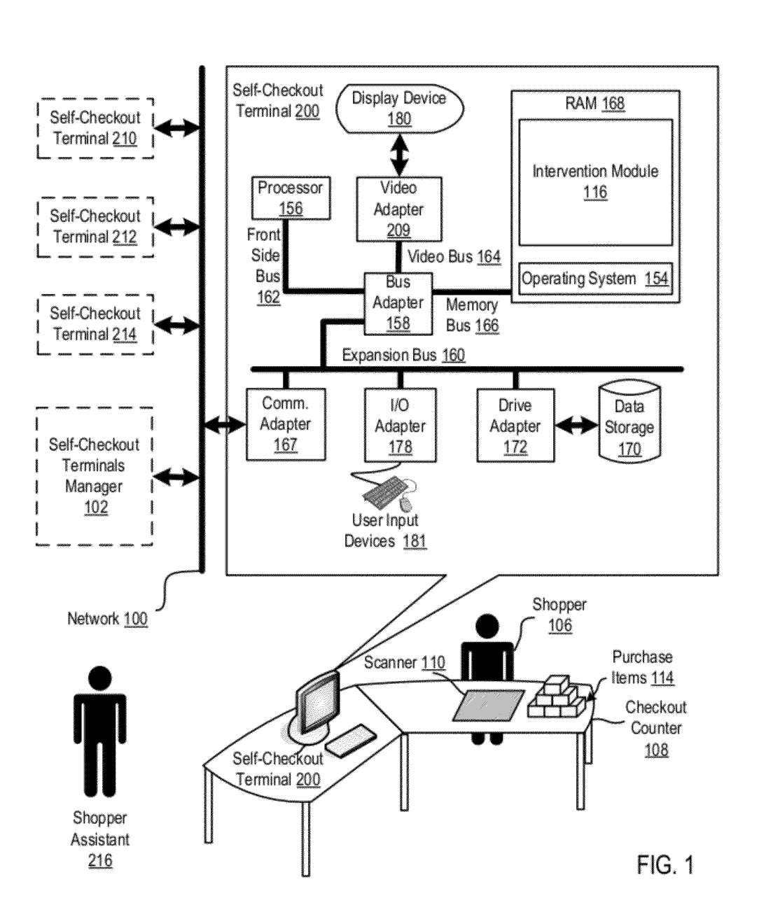

Example methods, apparatus, and products for assisting customers at a self-checkout terminal in accordance with the present invention are described with reference to the accompanying drawings, beginning with FIG. 1. Assisting customers at a self-checkout terminal in accordance with the present invention is generally implemented with computers, that is, with automated computing machinery. FIG. 1 therefore sets forth a block diagram of automated computing machinery comprising an self-checkout terminal (200) useful in assisting customers at a self-checkout terminal according to embodiments of the present invention.

The example self-checkout terminals (200, 210, 212, 214) of FIG. 1 are computing devices used by shoppers (106) to complete transactions at a checkout counters (108). The self-checkout terminals (200, 210, 212, 214) of FIG. 1 include user input devices such as, for example, a keyboard, a touch screen display, a microphone, and so on. Each self-checkout terminals (200, 210, 212, 214) of FIG. 1 is coupled to scanner (110) that is capable of identifying purchase items (114) using a barcode, RFID tag, or any other technology as will occur to those of skill in the art. The scanner (110) of FIG. 1 may be an external scanner or an internal scanner that is included as part of a self-checkout terminal (200). An external scanner may be embodied, for example, as a hand held scanner coupled to the self-checkout terminal via a cable. An internal scanner may be embodied, for example, as a scanner that is included within the physical structure of a self-checkout terminal. Examples of self-checkout terminals (200, 210, 212, 214) that may be improved in accordance with the present invention include Toshiba's ST-7000 Modular POS Terminal, IBM's SurePOS™ 700 series of POS terminals, NCR's 7452-3500 POS terminal, and so on. Self-checkout terminals (200, 210, 212, 214) that may be improved in accordance with the present invention include existing front-end systems, including hybrid front-end systems involving cashier lanes, self-checkout systems, mobile terminals, scan tunnels, and other technologies related to the cash/wrap process.

The example of FIG. 1 also includes a self-checkout terminals manager (102). The self-checkout terminals manager (102) is a module of automated computing machinery configured to receive information from self-checkout terminals (200, 210, 212, 214) and also configured to send information to self-checkout terminals (200, 210, 212, 214). In the example of FIG. 1, the self-checkout terminals manager (102) may receive information from self-checkout terminals (200, 210, 212, 214) and send information to self-checkout terminals (200, 210, 212, 214) over a data communications network (100). The self-checkout terminals manager (102) of FIG. 1 may be embodied, for example as a server or other stand alone computer capable of data communications over the network (100).

The self-checkout terminal (200) of FIG. 1 includes at least one computer processor (156) or ‘CPU’ as well as random access memory (168) (‘RAM’) which is connected through a high speed memory bus (166) and bus adapter (158) to processor (156) and to other components of the self-checkout terminal (200). Stored in RAM (168) is an intervention module (116), a module of computer program instructions improved for assisting customers at a self-checkout terminal according to embodiments of the present invention.

In the example of FIG. 1, the intervention module (116) includes computer program instructions that, when executed by the processor (156), request intervention from a shopper assistant (216). In the example of FIG. 1, the shopper assistant (216) is an employee of a business such as a grocery store or other retailer that has one or more self-checkout terminals (200, 210, 212, 214). The shopper assistant (216) assists customers with issues that arise at checkout, monitors the self-checkout terminals (200, 210, 212, 214) for abnormal activity such as theft or self-checkout terminal (200, 210, 212, 214) malfunction, and so on.

In the example of FIG. 1, the intervention module (116) also includes computer program instructions that, when executed by the processor (156), notify the shopper assistant (216) of the request for intervention. In the example of FIG. 1, the intervention module (116) may notify the shopper assistant (216) of the request for intervention by sending a message to a handheld device carried by the shopper assistant (216), by turning on a signaling device such a light at the self-checkout terminal (200), by placing the request for intervention in a request queue that is viewable by the shopper assistant (216), and so on.

In the example of FIG. 1 the intervention module (116) may also notify the shopper assistant (216) of the request for intervention, for example, by sending a message to another self-checkout terminal (210, 212, 214) that the shopper assistant (216) is at or alternatively by sending a message to the self-checkout terminals manager (102) over a network (100). The self-checkout terminals manager (102), upon receipt of the message, may notify the shopper assistant (216) of the request for intervention by sending a message to a handheld device carried by the shopper assistant (216), by placing the request for intervention in a request queue that is viewable by the shopper assistant (216), and so on. The self-checkout terminals manager (102) may store, in memory of the self-checkout terminals manager (102), a list of a requests for intervention and may send such a list to any of the self-checkout terminals (200, 210, 212, 214) upon request, such that the shopper assistant (216) can view the list of pending requests for intervention at any of the self-checkout terminals (200, 210, 212, 214).

In the example of FIG. 1, the intervention module (116) also includes computer program instructions that, when executed by the processor (156), check in the shopper assistant at the self-checkout terminal (200). In the example of FIG. 1, checking in the shopper assistant (216) at the self-checkout terminal (200) occurs when the shopper assistant (216) arrives at the self-checkout terminal (200) to assist the shopper (106). In the example of FIG. 1, checking in the shopper assistant (216) at the self-checkout terminal (200) may be carried out by the shopper assistant (216) scanning a form of identification such as an employee badge, by the shopper assistant (216) entering a code into the self-checkout terminal (200) indicating the shopper assistant (216) has arrived at the self-checkout terminal (200), and so on.

In the example of FIG. 1, the intervention module (116) also includes computer program instructions that, when executed by the processor (156), display an additional intervention request initiated at another self-checkout terminal (210, 212, 214). In the example of FIG. 1, displaying an additional intervention request initiated at another self-checkout terminal (210, 212, 214) may be carried out by displaying a list of all outstanding intervention requests that have been initiated at any of the self-checkout terminals (200, 210, 212, 214). As described above, such a list may be stored by the self-checkout terminals manager (102) and transmitted to any of the self-checkout terminals (200, 210, 212, 214) over the data communications network (100).

In the example of FIG. 1, multiple self-checkout terminals (200, 210, 212, 214) may be servicing multiple shoppers. The shopper assistant (216) may be responsible for assisting shoppers at each of the self-checkout terminals (200, 210, 212, 214). As such, displaying, at the self-checkout terminal (200) that the shopper assistant (216) is checked in to, an additional intervention request initiated at another self-checkout terminal (210, 212, 214) enables the shopper assistant (216) to more efficiently assist customers at the other self-checkout terminals (210, 212, 214). The shopper assistant (216) may assist customers at the other self-checkout terminals (210, 212, 214), for example, by remotely resolving an intervention request that is initiated at another self-checkout terminal (210, 212, 214). The shopper assistant (216) may also assist customers at the other self-checkout terminals (210, 212, 214), for example, by immediately proceeding to the self-checkout terminal (210, 212, 214) that generated the additional intervention request without requiring the shopper assistant (216) to return to a central monitoring terminal that is for the exclusive use of the shopper assistant (216).

Also stored in RAM (168) of the self-checkout terminal (200) is an operating system (154). Operating systems useful in assisting customers at a self-checkout terminal according to embodiments of the present invention include UNIX™, Linux™, Microsoft XP™, AIX™, IBM's i5/OS™, and others as will occur to those of skill in the art. The operating system (154) and the intervention module (116) in the example of FIG. 1 are shown in RAM (168), but many components of such software typically are stored in non-volatile memory also, such as, for example, on a disk drive (170). Although the operating system (154) and the intervention module (116) are stored in RAM (168) in the example of FIG. 1, readers will recognize that the operating system (154) and intervention module (116) may be stored in any form of computer memory, including local computer memory or remotely accessible computer memory. The operating system (154) and the intervention module (116) may also be implemented as computer program instructions, computer data stored in computer memory, special purpose hardware such as a field programmable gate array (‘FPGA’), application-specific integrated circuit (‘ASIC’), or any combination thereof.

The self-checkout terminal (200) of FIG. 1 includes disk drive adapter (172) coupled through expansion bus (160) and bus adapter (158) to processor (156) and other components of the self-checkout terminal (200). Disk drive adapter (172) connects non-volatile data storage to the self-checkout terminal (200) in the form of disk drive (170). Disk drive adapters useful in computers for assisting customers at a self-checkout terminal according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example self-checkout terminal (200) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards, mice, touch screen displays, and so on. The example self-checkout terminal (200) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example self-checkout terminal (200) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for assisting customers at a self-checkout terminal according to embodiments of the present invention include modems for wired dial-up communications, Ethernet (IEEE 802.3) adapters for wired data communications network communications, and 802.11 adapters for wireless data communications network communications.

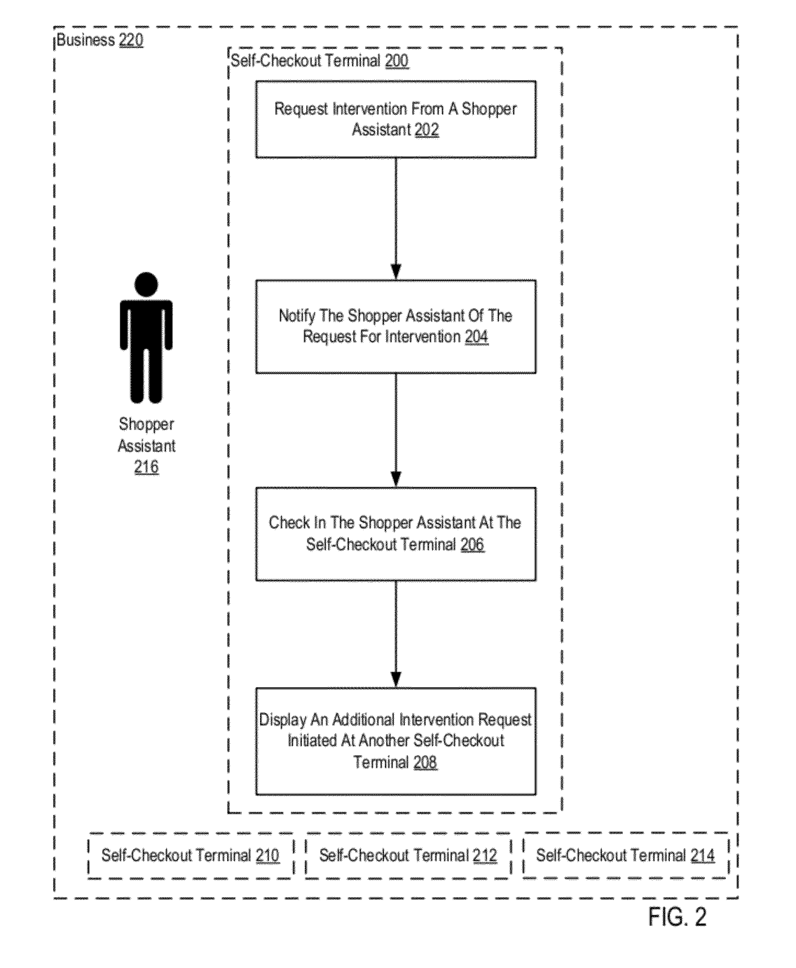

For further explanation, FIG. 2 sets forth a flow chart illustrating an example method for assisting customers at a self-checkout terminal (200) according to embodiments of the present invention that includes requesting (202), at a self-checkout terminal (200), intervention from a shopper assistant (216). In the example of FIG. 2, the shopper assistant (216) is an employee of a business (220) such as a grocery store or other retailer that has one or more self-checkout terminals (200, 210, 212, 214). In the example method of FIG. 2, each self-checkout terminal (200, 210, 212, 214) is a computing device used by an operator, such as a customer of the business (220), to complete transactions as described in more detail above with reference to FIG. 1.

In the example method of FIG. 2, requesting (202), at a self-checkout terminal (200), intervention from a shopper assistant (216) may occur at the behest of a customer at the self-checkout terminal (200). A customer may request (202) intervention from a shopper assistant (216), for example, by pressing a help button on the self-checkout terminal (200), by turning on a visual intervention request device such a light, and so on.

In the example method of FIG. 2, requesting (202), at a self-checkout terminal (200), intervention from a shopper assistant (216) may also occur at the behest the self-checkout terminal (200) itself. The self-checkout terminal (200) may request (202) intervention from a shopper assistant (216), for example, after detecting the occurrence of some event that requires intervention from a shopper assistant (216) such as an attempt to make an age restricted purchase such as the purchase of alcohol or cigarettes, after detecting the occurrence of a potential theft event such as the placement of an item in a bag without first scanning the item, after detecting the occurrence of a potential theft event such as the excessive use of coupons, after detecting no activity at the self-checkout terminal (200) for a predetermined period of time, and so on.

The example method of FIG. 2 also includes notifying (204), by the self-checkout terminal (200), the shopper assistant (216) of the request for intervention. Notifying (204) the shopper assistant (216) of the request for intervention may be carried out, for example, by sending a message to a handheld device carried by the shopper assistant (216), by turning on a signaling device such a light at the self-checkout terminal (200), by placing the request for intervention in a request queue that is viewable by the shopper assistant (216), and so on. In the example method of FIG. 2 notifying (204), by the self-checkout terminal (200), the shopper assistant (216) of the request for intervention may also be carried out through the use of an intermediary such as the self-checkout terminals manager described above.

The example method of FIG. 2 also includes checking (206) in the shopper assistant (216) at the self-checkout terminal (200). In the example method of FIG. 2, checking (206) in the shopper assistant (216) at the self-checkout terminal (200) occurs when the shopper assistant (216) arrives at the self-checkout terminal (200) to assist the operator of the self-checkout terminal (200). In the example method of FIG. 2, checking (206) in the shopper assistant (216) at the self-checkout terminal (200) may be carried out by the shopper assistant (216) scanning a form of identification such as an employee badge, by the shopper assistant (216) entering a code into the self-checkout terminal (200) indicating the shopper assistant (216) has arrived at the self-checkout terminal (200), and so on.

The example method of FIG. 2 also includes displaying (208), at the self-checkout terminal (200), an additional intervention request initiated at another self-checkout terminal (210, 212, 214). In the example method of FIG. 2, displaying (208), at the self-checkout terminal (200), an additional intervention request initiated at another self-checkout terminal (210, 212, 214) may be carried out by displaying a list of all outstanding intervention requests that have been initiated at any of the self-checkout terminals (200, 210, 212, 214).

In the example method of FIG. 2, multiple self-checkout terminals (200, 210, 212, 214) may be servicing multiple operators such as customers of the business (220). The shopper assistant (216) may be responsible for assisting customers at each of the self-checkout terminals (200, 210, 212, 214). As such, displaying (208), at the self-checkout terminal (200) that the shopper assistant (216) is checked in to, an additional intervention request initiated at another self-checkout terminal (210, 212, 214) enables the shopper assistant (216) to more efficiently assist customers at the other self-checkout terminals (210, 212, 214). The shopper assistant (216) may assist customers at the other self-checkout terminals (210, 212, 214), for example, by remotely resolving an intervention request that is initiated at another self-checkout terminal (210, 212, 214). The shopper assistant (216) may also assist customers at the other self-checkout terminals (210, 212, 214), for example, by immediately proceeding to the self-checkout terminal (210, 212, 214) that generated the additional intervention request without requiring the shopper assistant (216) to return to a central monitoring terminal that is for the exclusive use of the shopper assistant (216).

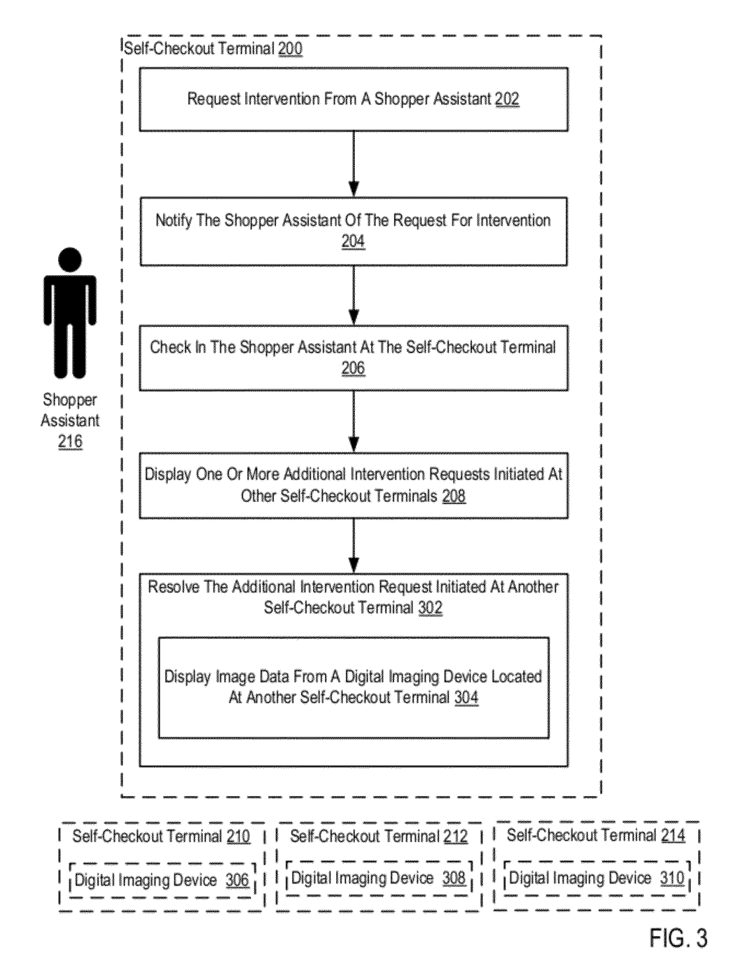

For further explanation, FIG. 3 sets forth a flow chart illustrating a further example method for assisting customers at a self-checkout terminal (200) according to embodiments of the present invention. The example method of FIG. 3 is similar to the example method of FIG. 2, including as it does, requesting (202), at the self-checkout terminal (200), intervention from a shopper assistant (216); notifying (204), by the self-checkout terminal (200), the shopper assistant (216) of the request for intervention; checking (206) in the shopper assistant (216) at the self-checkout terminal (200); and displaying (208), at the self-checkout terminal (200), an additional intervention request initiated at another self-checkout terminal (210, 212, 214).

The example method of FIG. 3 also includes resolving (302), at the self-checkout terminal (200), the additional intervention request initiated at another self-checkout terminal (210, 212, 214). In the example method of FIG. 3, resolving (302) the additional intervention request initiated at another self-checkout terminal (210, 212, 214) may be carried out by deleting the additional intervention request initiated at another self-checkout terminal (210, 212, 214) from a list of intervention requests, by re-enabling the self-checkout terminal (210, 212, 214) that generated the additional intervention request, and so on.

Consider an example in which the additional intervention request initiated at another self-checkout terminal (210, 212, 214) is an age verification event in which the age of a customer that is attempting to purchase alcohol needs to be verified. In such an example, the additional intervention request initiated at another self-checkout terminal (210, 212, 214) may be displayed (208) at the self-checkout terminal (200) that the shopper assistant (216) is presently checked in to. The shopper assistant (216) may visually inspect the customer that is attempting to purchase alcohol and may quickly determine that the customer is over the age limit that is required for the purchase of alcohol. The shopper assistant (216) may subsequently indicate that the customer is over the age limit that is required for the purchase of alcohol, for example, through the use of a touch screen display at the self-checkout terminal (200) or through the use of another input device at the self-checkout terminal (200). In response to receiving the indication that the customer is over the age limit that is required for the purchase of alcohol, the self-checkout terminal (200) may send a message to a central terminal manager indicating that the additional intervention request has been resolved, such that the self-checkout terminal (210, 212, 214) that generated the additional intervention request may be re-enabled for use by the customer.

In the example method of FIG. 3, resolving (302), at the self-checkout terminal (200), the additional intervention request initiated at another self-checkout terminal (210, 212, 214) can include displaying (304), at the self-checkout terminal (200), image data from a digital imaging device (306, 308, 310) located at another self-checkout terminal (210, 212, 214). In the example of FIG. 3, the digital imaging device (306, 308, 310) located at another self-checkout terminal (210, 212, 214) may be embodied as a digital camera, digital video recorder, a charge coupled device (‘CCD’), complementary metal-oxide-semiconductor (‘CMOS’) active pixel sensor, or other image sensor. Each digital imaging device (306, 308, 310) located at another self-checkout terminal (210, 212, 214) may capture image data that is subsequently transmitted to the self-checkout terminal (200) for inspection by the shopper assistant (216). For example, the digital imaging device (306, 308, 310) located at another self-checkout terminal (210, 212, 214) may capture image data of a customer and/or a driver's license for the customer to remotely verify the age of the customer when the customer is attempting to make an age-restricted purchase. After inspecting the image data, the shopper assistant (216) may subsequently indicate that the customer is over the age limit that is required for the purchase of alcohol through the use of a touch screen display at the self-checkout terminal (200) or through the use of another input device at the self-checkout terminal (200). In response to receiving the indication that the customer is over the age limit that is required for the purchase of alcohol, the self-checkout terminal (200) may send a message to a central terminal manager indicating that the additional intervention request has been resolved, such that the self-checkout terminal (210, 212, 214) that generated the additional intervention request may be re-enabled for use by the customer.

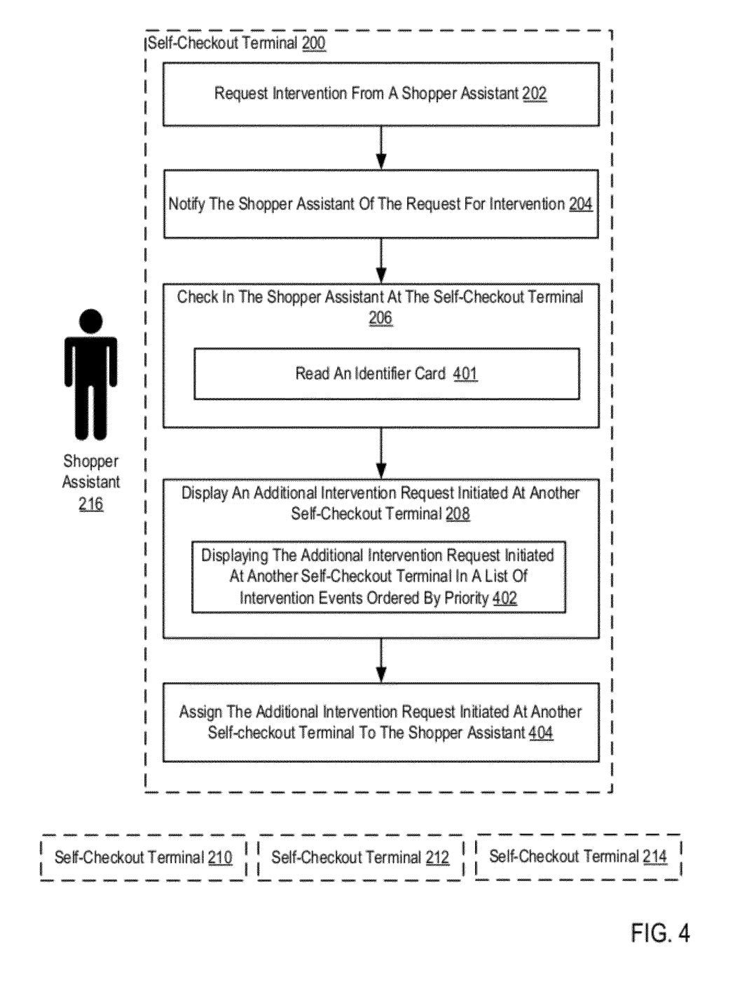

For further explanation, FIG. 4 sets forth a flow chart illustrating a further example method for assisting customers at a self-checkout terminal (200) according to embodiments of the present invention. The example method of FIG. 4 is similar to the example methods of FIG. 2 and FIG. 3, including as it does, requesting (202), at the self-checkout terminal (200), intervention from a shopper assistant (216); notifying (204), by the self-checkout terminal (200), the shopper assistant (216) of the request for intervention; checking (206) in the shopper assistant (216) at the self-checkout terminal (200); and displaying (208), at the self-checkout terminal (200), an additional intervention request initiated at another self-checkout terminal (210, 212, 214).

In the example method of FIG. 4, checking (206) in the shopper assistant (216) at the self-checkout terminal (200) includes reading (401) an identifier card. The identifier card may be embodied as an employee badge or other identifier encoded with information to identify the shopper assistant (216). In such an example, the self-checkout terminal (200) can check (206) in the shopper assistant (216) by reading (401) the identifier card, for example, using a scanner, bar code reader, or other device at the self-checkout terminal (200). In alternative embodiments, the the self-checkout terminal (200) can check (206) in the shopper assistant (216) by capturing a digital image of the shopper assistant (216) and comparing the image to an image template, by sensing that the shopper assistant (216) is at the self-checkout terminal (216) using radio-frequency identification (‘RFID’) technology or global positioning system (‘GPS’) technology, and so on.

In the example method of FIG. 4, displaying (208), at the self-checkout terminal (200), an additional intervention request initiated at another self-checkout terminal (210, 212, 214) includes displaying (402) the additional intervention request initiated at another self-checkout terminal (210, 212, 214) in a list of intervention events ordered by priority. As described above, a self-checkout terminal manager may receive intervention events from each self-checkout terminal (200, 210, 212, 214) and store the intervention events in an intervention events table. Displaying (402) the additional intervention request initiated at another self-checkout terminal (210, 212, 214) in a list of intervention events may therefore be carried out by receiving the intervention events table from the self-checkout terminal manager and displaying the intervention events table at the self-checkout terminal (200).

In the example method of FIG. 4, the intervention events in the intervention events table may be assigned a priority. The priority may be based on type of intervention events, for example, such that theft events are prioritized over age verification events.

The priority may be based on the order in which the intervention events were initiated, the ease associated with resolving an intervention event, and so on. In the example method of FIG. 4, displaying (402) the additional intervention request initiated at another self-checkout terminal (210, 212, 214) in a list of intervention events ordered by priority may be carried out by receiving the intervention events table from the self-checkout terminal manager and displaying the intervention events table, sorted by priority, at the self-checkout terminal (200).

The example method of FIG. 4 also includes assigning (404), at the self checkout terminal (200), the additional intervention request initiated at another self-checkout terminal (210, 212, 214) to the shopper assistant (216). In the example of FIG. 4, the additional intervention request initiated at another self-checkout terminal (210, 212, 214) may be assigned (404) to the shopper assistant (216) so that the shopper assistant (216) can resolve the additional intervention request remotely or so that the shopper assistant (216) can go to the self-checkout terminal (210, 212, 214) that initiated the additional intervention request to resolve the additional intervention request in-person.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method of assisting customers at a self-checkout terminal, the method comprising:
requesting, at the self-checkout terminal, intervention from a shopper assistant;
notifying, by the self-checkout terminal, the shopper assistant of the request for intervention;
checking in the shopper assistant at the self-checkout terminal, wherein checking in the shopping assistant at the self-checkout terminal includes:
capturing a digital image of the shopping assistant; and
comparing the captured image to an image template; and
displaying, at the self-checkout terminal, an additional intervention request initiated at another self-checkout terminal.

2. The method of claim 1 further comprising resolving, at the self-checkout terminal, the additional intervention request initiated at another self-checkout terminal.

3. The method of claim 2 wherein resolving, at the self-checkout terminal, the additional intervention request initiated at another self-checkout terminal includes displaying, at the self-checkout terminal, image data from a digital imaging device located at another self-checkout terminal.

4. The method of claim 1 further comprising assigning, at the self checkout terminal, the additional intervention request initiated at another self-checkout terminal to the shopper assistant.

5. The method of claim 1 wherein displaying, at the self-checkout terminal, an additional intervention request initiated at another self-checkout terminal includes displaying the additional intervention request initiated at another self-checkout terminal in a list of intervention events ordered by priority.

6. (canceled)

7. A self-checkout terminal for assisting customers, the self-checkout terminal comprising a computer processor, a computer memory operatively coupled to the computer processor, the computer memory having disposed within it computer program instructions that, when executed, cause the self-checkout terminal to carry out the steps of:
requesting, at the self-checkout terminal, intervention from a shopper assistant;
notifying, by the self-checkout terminal, the shopper assistant of the request for intervention;
checking in the shopper assistant at the self-checkout terminal, wherein checking in the shopping assistant at the self-checkout terminal includes:
capturing a digital image of the shopping assistant; and
comparing the captured image to an image template; and
displaying, at the self-checkout terminal, an additional intervention request initiated at another self-checkout terminal.

8. The self-checkout terminal of claim 7 further comprising computer program instructions that, when executed, cause the self-checkout terminal to carry out the step of resolving, at the self-checkout terminal, the additional intervention request initiated at another self-checkout terminal.

9. The self-checkout terminal of claim 8 wherein resolving, at the self-checkout terminal, the additional intervention request initiated at another self-checkout terminal includes displaying, at the self-checkout terminal, image data from a digital imaging device located at another self-checkout terminal.

10. The self-checkout terminal of claim 7 further comprising computer program instructions that, when executed, cause the self-checkout terminal to carry out the step of assigning, at the self checkout terminal, the additional intervention request initiated at another self-checkout terminal to the shopper assistant.

11. The self-checkout terminal of claim 7 wherein displaying, at the self-checkout terminal, an additional intervention request initiated at another self-checkout terminal includes displaying the additional intervention request initiated at another self-checkout terminal in a list of intervention events ordered by priority.

12. (canceled)

13. A computer program product for assisting customers at a self-checkout terminal, the computer program product disposed upon a computer readable storage medium, the computer program product comprising computer program instructions that, when executed, cause a computer to carry out the steps of:
requesting, at the self-checkout terminal, intervention from a shopper assistant;
notifying, by the self-checkout terminal, the shopper assistant of the request for intervention;
checking in the shopper assistant at the self-checkout terminal, wherein checking in the shopping assistant at the self-checkout terminal includes:
capturing a digital image of the shopping assistant; and
comparing the captured image to an image template; and
displaying, at the self-checkout terminal, an additional intervention request initiated at another self-checkout terminal.

14. The computer program product of claim 13 further comprising computer program instructions that, when executed, cause a computer to carry out the step of resolving, at the self-checkout terminal, the additional intervention request initiated at another self-checkout terminal.

15. The computer program product of claim 14 wherein resolving, at the self-checkout terminal, the additional intervention request initiated at another self-checkout terminal includes displaying, at the self-checkout terminal, image data from a digital imaging device located at another self-checkout terminal.

16. The computer program product of claim 13 further comprising computer program instructions that, when executed, cause a computer to carry out the step of assigning, at the self checkout terminal, the additional intervention request initiated at another self-checkout terminal to the shopper assistant.

17. The computer program product of claim 13 wherein displaying, at the self-checkout terminal, an additional intervention request initiated at another self-checkout terminal includes displaying the additional intervention request initiated at another self-checkout terminal in a list of intervention events ordered by priority.

18. (canceled)
